(19) United States
(12) Patent Application Publication
(10) Pub. No.: US 2015/0358984 A1
(43) Pub. Date: Dec. 10, 2015

(54) ROUTER DEVICE

(71) Applicant: NTT DOCOMO, INC., Tokyo (JP)

(72) Inventors: Tooru Uchino, Tokyo (JP); Hideaki Takahashi, Tokyo (JP); Akihito Hanaki, Tokyo (JP); Wuri Andarmawanti Hapsari, Tokyo (JP)

(73) Assignee: NTT DOCOMO, INC., Tokyo (JP)

(21) Appl. No.: 14/654,888

(22) PCT Filed: Dec. 11, 2013
(86) PCT No.: PCT/JP2013/083174

§ 371 Date: Jun. 23, 2015

(30) Foreign Application Priority Data
Dec. 28, 2012 (JP) 2012-287443

(51) Int. Cl. H04W 72/10

(52) U.S. Cl. CPC H04W 72/10; H04W 84/045

(57) ABSTRACT

An object of the present invention is to perform appropriate priority control even when tethering is performed. A WiFi router 10 of the present invention includes: an establishment unit 12 configured to establish a priority call bearer and a low priority call bearer between the WiFi router 10 and a radio base station eNB; and a control unit 13 configured to determine through which one of the priority call bearer and the low priority call bearer received data is to be transferred, based on a priority of the received data.

### TECHNICAL FIELD

The present invention relates to a router device.

### BACKGROUND ART

An LTE (Long Term Evolution) radio base station eNB is configured to perform scheduling basically based on the priority of a bearer established between the radio base station eNB and a mobile station UE.

Communication using an LTE radio access network as a backhaul line (tethering) is expected to increase due to recent wide spread use of WiFi routers which are router devices for WiFi specified in IEEE 802.11b and due to an increase in transmission rate of data achieved by introduction of “CA (Carrier Aggregation)” (see FIG. 8).

### PRIOR ART DOCUMENT

### Non-Patent Document

Non-patent document 1: 3GPP TS 36.300 (v11.3.0)

### SUMMARY OF THE INVENTION

As shown in FIG. 8, when mobile stations UE are performing tethering, the priority of a bearer established for a WiFi router is uniformly applied to data flowing through the WiFi router. Accordingly, this method has a problem that priority control cannot be performed with data transmitted by a priority call terminal UE#1 and data transmitted by a general call terminal UE#2 being distinguished from each other.

Hence, for example, the following problem may occur. When the priority call terminal UE#1 is performing tethering via the WiFi router establishing a low priority call bearer between the WiFi router and the radio base station eNB, the data transmitted by the priority call terminal UE#1 is scheduled as data with a low priority.

Moreover, the existing radio base stations eNB are not designed to perform priority control while considering contents of received data.

Accordingly, the existing radio base stations eNB have a problem that, when the priority of a bearer established between the radio base station eNB and a terminal UE#3 with a priority lower than that of the priority call terminal UE#1 is higher than the priority of the bearer established between the WiFi router and the radio base station eNB, data transmitted by the terminal UE#3 may be handled preferentially over the data transmitted by the priority call terminal UE#1.

The present invention has been made in view of the problems described above, and an object is to provide a router device which can perform appropriate priority control even when tethering is performed.

A first feature of the present invention is summarized as a router device including: an establishment unit configured to establish a priority call bearer and a low priority call bearer between the router device and a radio base station; and a control unit configured to determine through which one of the priority call bearer and the low priority call bearer received data is to be transferred, based on a priority of the received data.

A second feature of the present invention is summarized as a router device including an establishment unit configured to establish a priority call bearer or a low priority call bearer between the router device and a radio base station. Here, the establishment unit changes the low priority call bearer established between the router device and the radio base station to the priority call bearer when connection of a priority call terminal is detected.

A third feature of the present invention is summarized as a router device including: an establishment unit configured to establish a low priority call bearer between the router device and the radio base station; and a control unit configured to discard data from a terminal with a priority relatively lower than that of a priority call terminal when a transmission rate of data from the priority call terminal falls below a predetermined threshold value.

A fourth feature of the present invention is summarized as a router device configured to notify a radio base station of capability information indicating whether the router device is capable of determining through which one of a priority call bearer and a low priority call bearer received data is to be transferred, based on the received data.

A fifth feature of the present invention is summarized as a router device configured to notify a radio base station of capability information indicating whether the router device is capable of changing a low priority call bearer established between the router device and the radio base station to a priority call bearer when connection of a priority call terminal is detected.

A sixth feature of the present invention is summarized as a router device configured to notify a radio base station of capability information indicating whether the router device is capable of discarding data from a terminal with a priority relatively lower than that of a priority call terminal when a transmission rate of data from the priority call terminal falls below a predetermined threshold value.

### BRIEF DESCRIPTION OF THE DRAWINGS

FIG. 1 is an overall configuration diagram of a mobile communication system in a first embodiment of the present invention.

FIG. 2 is a functional block diagram of a WiFi router 10 in a first embodiment of the present invention.

FIG. 3 is a flowchart showing an operation of the WiFi router 10 in a first embodiment of the present invention.

FIG. 4 is an overall configuration diagram of a mobile communication system in a modified example 1 of the present invention.

FIG. 5 is a flowchart showing an operation of the WiFi router 10 in the modified example 1 of the present invention.

FIG. 6 is an overall configuration diagram of a mobile communication system in a modified example 2 of the present invention.

FIG. 7 is a flowchart showing an operation of the WiFi router 10 in the modified example 2 of the present invention.

FIG. 8 is a view for explaining a conventional art.

### DETAILED DESCRIPTION

### Mobile Communication System in First Embodiment of Present Invention

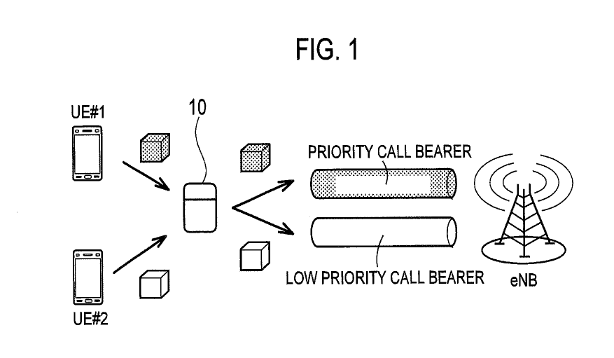

A mobile communication system in a first embodiment of the present invention is described with reference to FIGS. 1 to 3.

As shown in FIG. 1, the mobile communication system in the embodiment is a LTE mobile communication system and includes a radio base station eNB, a WiFi router 10, a priority call terminal UE#1, and a general call terminal UE#2.

In the mobile communication system, the priority call terminal UE#1 is a terminal (mobile station) UE with a high priority and the general call terminal UE#2 is a terminal (mobile station) UE with a priority relatively lower than that of the priority call terminal UE#1.

Note that the terminals UE may directly notify the WiFi router 10 of the priorities of the respective terminals UE or may indirectly notify the WiFi router 10 of the priorities via the radio base station eNB.

In the example of FIG. 1, a priority call bearer and a low priority call bearer are established between the radio base station eNB and the WiFi router 10.

In this example, the priority call bearer is a bearer for transferring high priority data such as data from the priority call terminal UE#1, for example, and the low priority call bearer is a bearer for transferring low priority data such as data from the general call terminal UE#2, for example.

Note that several levels (for example, high, medium, low, very low, and the like) of priorities may be set for the priorities of the bearers established between the radio base station eNB and the WiFi router 10.

In the description, a bearer with a specific level of priority is referred to as the priority call bearer, and a bearer with a level of priority relatively lower than the priority of the priority call bearer is referred to as the low priority call bearer.

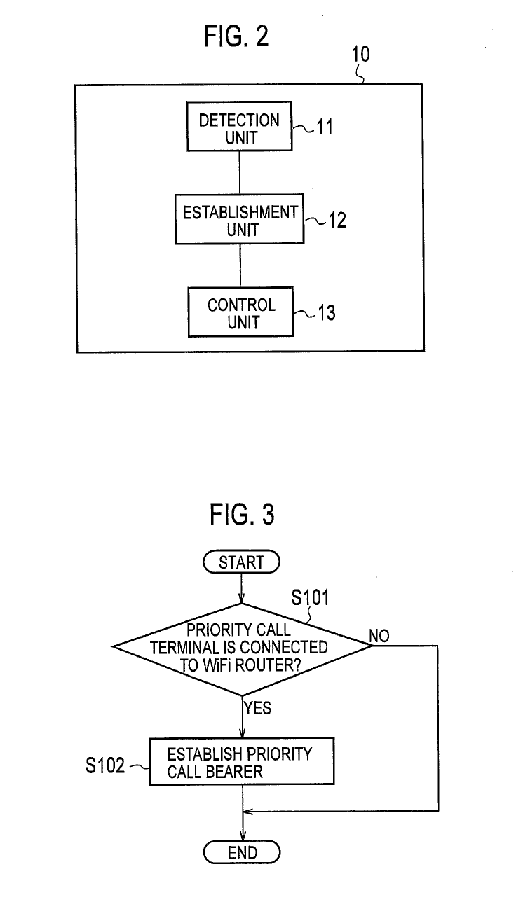

As shown in FIG. 2, the WiFi router 10 in the embodiment includes a detection unit 11, an establishment unit 12, and a control unit 13.

The detection unit 11 is configured to detect connection of the priority call terminal UE#1 and/or the general call terminal UE#2 to the WiFi router 10.

The establishment unit 12 is configured to establish the priority call bearer and the low priority call bearer between the WiFi router 10 and the radio base station eNB.

For example, the establishment unit 12 may be configured to establish no bearer between the WiFi router 10 and the radio base station eNB when no terminal is connected to the WiFi router 10.

In such a case, the establishment unit 12 may be configured to establish the low priority call bearer between the WiFi router 10 and the radio base station eNB when the detection unit 11 detects the connection of the general call terminal UE#2 to the WiFi router 10.

Alternatively, the establishment unit 12 may be configured to establish the low priority call bearer between the WiFi router 10 and the radio base station eNB even when no terminal is connected to the WiFi router 10.

In such a case, the establishment unit 12 may be configured to establish the priority call bearer between the WiFi router 10 and the radio base station eNB when the detection unit 11 detects the connection of priority call terminal UE#1 to the WiFi router 10.

Moreover, the establishment unit 12 may be configured to establish a bearer for each terminal UE or establish a bearer for each priority when a plurality of terminals UE with the same priority exist.

The control unit 13 is configured to perform scheduling of received data based on the priority of the received data.

Specifically, the control unit 13 is configured to determine through which one of the priority call bearer and the low priority call bearer the data received from the priority call terminal UE#1 or the general call terminal UE#2 is to be transferred, based on the priority of the received data.

Moreover, when the WiFi router 10 receives pieces of data with the same priority, the control unit 13 may perform scheduling of the received pieces of data based on the holding time and accumulated amount of piece of data.

Furthermore, the WiFi router 10 may be configured to notify the radio base station eNB of capability information indicating whether the WiFi router 10 can determine through which one of the priority call bearer and the low priority call bearer the received data is to be transferred, based on the priority of the received data.

An operation of the mobile communication system in the embodiment, specifically the WiFi router 10 in the embodiment is described below with reference to FIG. 3.

As shown in FIG. 3, in step S101, the WiFi router 10 determines whether the priority call terminal UE#1 is connected thereto.

If “YES”, the operation proceeds to step S102. If “NO”, the operation is terminated.

In step S102, the WiFi router 10 establishes the priority call bearer between the WiFi router 10 and the radio base station eNB.

### Modified Example 1

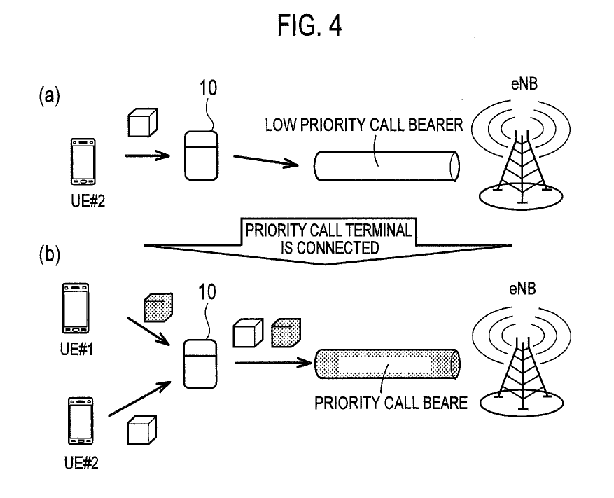

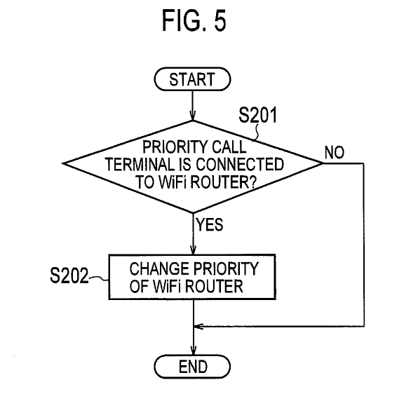

A mobile communication system in a modified example 1 of the present invention is described with reference to FIGS. 4 and 5. The mobile communication system in the modified example 1 is described below while focusing on differences from the aforementioned mobile communication system in the first embodiment.

The mobile communication system is configured such that, when the priority call terminal UE#1 is connected to the WiFi router 10 as shown in part (b) of FIG. 4 in a state where only the general call terminal UE#2 is connected to the WiFi router 10 and the low priority call bearer is established between the WiFi router 10 and the radio base station eNB as shown in part (a) of FIG. 4, the detection unit 11 detects the connection of the priority call terminal UE#1, and the establishment unit 12 changes the low priority call bearer established between the WiFi router 10 and the radio base station eNB to the priority call bearer.

The priority of the data transmitted by the terminals connected to the WiFi router 10 is thus uniquely determined.

Note that the mobile communication system may be configured such that, when the connection of the priority call terminal UE#1 is terminated, the bearer established between the WiFi router 10 and the radio base station eNB is changed back to the low priority call bearer from the priority call bearer.

Moreover, the WiFi router 10 may be configured to notify the radio base station eNB of capability information indicating whether the WiFi router 10 can change the low priority call bearer established between the WiFi router 10 and the radio base station eNB to the priority call bearer when the connection of the priority call terminal UE#1 is detected.

An operation of the mobile communication system in the modified example 1, specifically the WiFi router 10 in the modified example 1 is described below with reference to FIG. 5.

As shown in FIG. 5, in step S201, the WiFi router 10 determines whether the priority call terminal UE#1 is connected thereto.

If “YES”, the operation proceeds to step S202. If “NO”, the operation is terminated.

In step S202, the WiFi router 10 changes the low priority call bearer established between the WiFi router 10 and the radio base station eNB to the priority call bearer.

### Modified Example 2

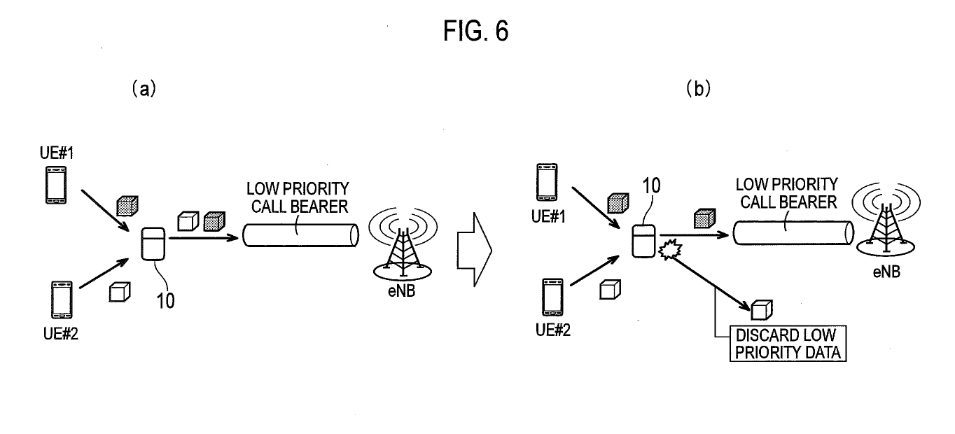

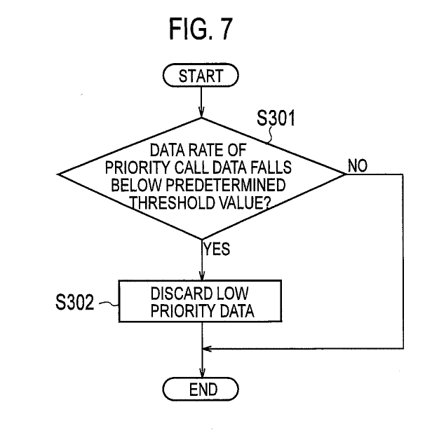

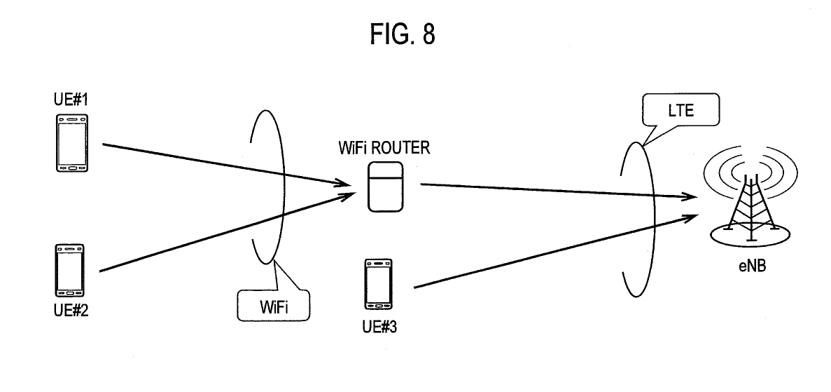

A mobile communication system in a modified example 2 of the present invention is described with reference to FIGS. 6 and 7. The mobile communication system in the modified example 2 is described below while focusing on differences from the aforementioned mobile communication system in the first embodiment.

The mobile communication system is configured such that, when a transmission rate (data rate) of data from the priority call terminal UE#1 falls below a predetermined threshold value (i.e. when QoS (Quality of Service) of the data from the priority call terminal UE#1 cannot be guaranteed) in a state where the low priority call bearer is established between the WiFi router 10 and the radio base station eNB and the priority call terminal UE#1 and the general call terminal UE#2 are connected to the WiFi router 10 as shown in part (a) of FIG. 6, the control unit 13 discards data (data with a low priority) from the general call terminal UE#2 as shown in part (b) of FIG. 6.

The transmission rate described above may be a mean transmission rate in a predetermined period, a maximum transmission rate in a predetermined period, or a minimum transmission rate in a predetermined period.

The control unit 13 may be configured to discard the data (data with a low priority) from the general call terminal UE#2 (i.e. the terminal UE#2 with a priority relatively lower than that of the priority call terminal UE#1) when the detection unit 11 detects that the transmission rate of the data from the priority call terminal UE#1 falls below the predetermined threshold value. Alternatively, the control unit 13 may be configured to discard the data (data with a low priority) from the general call terminal UE#2 when the radio base station eNB or the priority call terminal UE#1 notifies the control unit 13 that the transmission rate of the data from the priority call terminal UE#1 falls below the predetermined threshold value.

The predetermined threshold value may be set for each terminal, for each bearer, or for each “UE category”.

The control unit 13 may be configured to perform the aforementioned discarding of data only for a certain period when the transmission rate of the data from the priority call terminal UE#1 falls below the predetermined threshold value.

Moreover, the WiFi router 10 may be configured to notify the radio base station eNB of capability information indicating whether the WiFi router 10 can discard the data from the terminal UE#2 with a priority relatively lower than that of the priority call terminal UE#1 when the transmission rate of the data from the priority call terminal UE#1 falls below the predetermined threshold value.

An operation of the mobile communication system in the modified example 2, specifically the WiFi router 10 in the modified example 2 is described below with reference to FIG. 7.

As shown in FIG. 7, in step S301, the WiFi router 10 determines whether the transmission rate of the data from the priority call terminal UE#1 falls below the predetermined threshold value.

If “YES”, the operation proceeds to step S302. If “NO”, the operation is terminated.

In step S302, the WiFi router 10 discards the data (data with a low priority) from the general call terminal UE#2.

The features of the present embodiment may also be expressed as follows.

A first feature of the present embodiment is summarized as a WiFi router 10 (router device) including: an establishment unit 12 configured to establish a priority call bearer and a low priority call bearer between the WiFi router 10 and a radio base station eNB; and a control unit 13 configured to determine through which one of the priority call bearer and the low priority call bearer received data is to be transferred, based on a priority of the received data.

In such a configuration, the WiFi router 10 can transfer the received data through a bearer with an appropriate priority when tethering is performed.

In the first feature of the present embodiment, the establishment unit 12 may be configured to establish the priority call bearer when connection of a priority call terminal UE#1 is detected.

In such a configuration, the WiFi router 10 establishes no priority call bearer between the WiFi router 10 and the radio base station eNB when no priority call terminal UE#1 is connected, and can thereby prevent waste of radio resources.

A second feature of the present embodiment is summarized as a WiFi router 10 including an establishment unit 12 configured to establish a priority call bearer or a low priority call bearer between the WiFi router 10 and a radio base station eNB. Here, the establishment unit 12 changes the low priority call bearer established between the WiFi router 10 and the radio base station eNB to the priority call bearer when connection of a priority call terminal UE#1 is detected.

In such a configuration, the WiFi router 10 establishes the priority call bearer between the WiFi router 10 and the radio base station eNB when the priority call terminal UE#1 is connected, and establishes the low priority call bearer between the WiFi router 10 and the radio base station eNB when no priority call terminal UE#1 is connected. Accordingly, the WiFi router 10 can perform appropriate priority control while effectively using the radio resources.

A third feature of the present embodiment is summarized as a WiFi router 10 including: an establishment unit 12 configured to establish a low priority call bearer between the WiFi router 10 and the radio base station eNB; and a control unit 13 configured to discard data from a general call terminal UE#2 when a transmission rate of data from the priority call terminal UE#1 falls below a predetermined threshold value.

In such a configuration, the WiFi router 10 can communicate the data from the priority call terminal UE#1 more easily by discarding data from the terminal (general call terminal) UE#2 with a priority relatively lower than that of the priority call terminal UE#1 when the transmission rate of the data from the priority call terminal UE#1 falls below the predetermined threshold.

In the third feature of the present embodiment, the predetermined threshold may be set for each terminal, each bearer, or each “UE category (terminal category)”.

In such a configuration, the WiFi router 10 can perform more flexible priority control by setting the predetermined threshold value for each terminal, each bearer, or each “UE category”.

In the third feature of the present embodiment, the control unit 13 may the above described discard the data only for a certain period.

In such a configuration, the WiFi router 10 can swiftly stop the discarding of the data from the general call terminal UE#2 when the communication state of the data from the priority call terminal UE#1 recovers to a favorable condition.

Furthermore, the WiFi router 10 and the terminals UE#1 and UE#2 may be configured to notify the radio base station eNB of the capability information on whether the aforementioned priority control is possible, and the radio base station eNB may be configured to perform the aforementioned priority control based on the capability information.

It should be noted that the foregoing operations of the priority call terminal UE#1, the general call terminal UE#2, the radio base stations eNB, and the WiFi router 10 may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the priority call terminal UE#1, the general call terminal UE#2, the radio base stations eNB, and the WiFi router 10. Otherwise, the storage medium and the processor may be provided as discrete components inside the priority call terminal UE#1, the general call terminal UE#2, the radio base stations eNB, and the WiFi router 10.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2012-287443 (filed on Dec. 28, 2012) is incorporated by reference in the present specification.

### INDUSTRIAL APPLICABILITY

As described above, the present invention can provide a router device which can perform an appropriate priority control even when tethering is performed.

### EXPLANATION OF THE REFERENCE NUMERALS

eNB radio base station
UE#1 priority call terminal
UE#2 general call terminal
10 WiFi router
11 detection unit
12 establishment unit
13 control unit

1. A router device comprising:
an establishment unit configured to establish a priority call bearer and a low priority call bearer between the router device and a radio base station; and
a control unit configured to determine through which one of the priority call bearer and the low priority call bearer received data is to be transferred, based on a priority of the received data.

2. The router device according to claim 1, wherein the establishment unit is configured to establish the priority call bearer when connection of a priority call terminal is detected.

3. A router device comprising an establishment unit configured to establish a priority call bearer or a low priority call bearer between the router device and a radio base station, wherein
the establishment unit changes the low priority call bearer established between the router device and the radio base station to the priority call bearer when connection of a priority call terminal is detected.

4. A router device comprising:
an establishment unit configured to establish a low priority call bearer between the router device and a radio base station; and
a control unit configured to discard data from a terminal with a priority relatively lower than that of a priority call terminal when a transmission rate of data from the priority call terminal falls below a predetermined threshold value.

5. The router device according to claim 4, wherein the predetermined threshold is set for each terminal, each bearer, or each terminal category.

6. The router device according to claim 4, wherein the control unit discards the data only for a certain period.

7. A router device configured to notify a radio base station of capability information indicating whether the router device is capable of determining through which one of a priority call bearer and a low priority call bearer received data is to be transferred, based on the received data.

8. A router device configured to notify a radio base station of capability information indicating whether the router device is capable of changing a low priority call bearer established between the router device and the radio base station to a priority call bearer when connection of a priority call terminal is detected.

9. A router device configured to notify a radio base station of capability information indicating whether the router device is capable of discarding data from a terminal with a priority relatively lower than that of a priority call terminal when a transmission rate of data from the priority call terminal falls below a predetermined threshold value.

10. The router device according to claim 5, wherein the control unit discards the data only for a certain period.
